(19) United States
(12) Patent Application Publication
(10) Pub. No.: US 2013/0206289 A1
(43) Pub. Date: Aug. 15, 2013

(54) HIGH-STRENGTH HOT-ROLLED STEEL SHEET HAVING EXCELLENT FORMABILITY AND METHOD FOR MANUFACTURING THE SAME

(71) Applicants: Katsumi Nakajima, Kanagawa (JP); Tetsuya Mega, Tokyo (JP); Reiko Mizuno, Hiroshima (JP); Noriaki Moriyasu, Chiba (JP)

(72) Inventors: Katsumi Nakajima, Kanagawa (JP); Tetsuya Mega, Tokyo (JP); Reiko Mizuno, Hiroshima (JP); Noriaki Moriyasu, Chiba (JP)

(73) Assignee: JFE STEEL CORPORATION, Tokyo (JP)

(21) Appl. No.: 13/814,947

(22) PCT Filed: Aug. 9, 2011
(86) PCT No.: PCT/JP2011/068494

§ 371 Date: Apr. 15, 2013

(30) Foreign Application Priority Data
Aug. 10, 2010 (JP) 2010-179246
Aug. 2, 2011 (JP) 2011-168870

(51) Int. Cl. C21D 8/00; C22C 38/02; C22C 38/14; C22C 38/06; C22C 38/12; C22C 38/00; C22C 38/04

(52) U.S. Cl. CPC C21D 8/005; C22C 38/001; C22C 38/005; C22C 38/02; C22C 38/04; C22C 38/06; C22C 38/12; C22C 38/14
USPC 148/602; 148/320; 148/331; 148/330

(57) ABSTRACT

A high-strength hot-rolled steel sheet having excellent formability has a composition containing, by mass, 0.04% to 0.1% of C, 0.3% to 1.3% of Si, 0.8% to 1.8% of Mn, 0.03% or less of P, 0.005% or less of S, 0.005% or less of N, 0.005% to 0.1% of Al, and at least one element selected from 0.002% to less than 0.03% of Ti, 0.002% to less than 0.03% of V, and 0.002% to less than 0.02% of Nb, the balance being Fe and incidental impurities. The steel sheet has a microstructure in which the area fraction of ferrite phase in the entire structure is 85% or more, the area fraction of bainite phase in the entire structure is 10% or less, the area fraction of phases other than the ferrite and bainite phases in the entire structure is 5% or less, and the area fraction of acicular ferrite phase in the entire ferrite phase is 30% to less than 80%.

### Related Applications

This is a §371 of International Application No. PCT/JP2011/068494, with an international filing date of Aug. 9, 2011 (WO 2012/020847 A1, published Feb. 16, 2012), which is based on Japanese Patent Application Nos. 2010-179246, filed Aug. 10. 2010, and 2011-168870, filed Aug. 2, 2011, the subject matter of which is incorporated herein by reference.

### TECHNICAL FIELD

This disclosure relates generally to high-strength hot-rolled steel sheets used for automotive components, including structural components such as members and frames, and chassis components such as suspensions, of car bodies, and particularly to high-strength hot-rolled steel sheets having excellent formability with tensile strengths, TS, of 490 to less than 590 MPa and methods for manufacturing such high-strength hot-rolled steel sheets.

### BACKGROUND

Recently, high-strength steel sheets have been extensively used to reduce car body weight. In particular, cost-effective high-strength hot-rolled steel sheets have been increasingly used for members that do not require excellent surface quality, including structural components and chassis components of cur bodies.

Conventionally available strengthening techniques for high-strength hot-roiled steel sheets with a TS of 490 to 590 MPa include a) solid-solution strengthening by dissolving an element such as Si in the ferrite phase; b) precipitation strengthening by forming a carbonitride of an element such as Ti, Nb, or V in the ferrite phase; e) structure strengthening by forming a phase such as a martensite phase or bainite phase in the ferrite phase; and combinations thereof. Various high-strength hot-rolled steel sheets have been developed depending on the required properties. Examples of inexpensive, general-purpose steel sheets include solid-solution-strengthened or precipitation-strengthened hot-rolled steel sheets (HSLA). Examples of steel sheets requiring ductility include multiple phase steel sheets (DP steel sheets), which are structure-strengthened steel sheets composed of ferrite and martensite phases. Examples of steel sheets requiring stretch flange formability include steel sheets structure-strengthened with a bainite phase.

As an example of a high-strength hot-rolled steel sheet having excellent stretch flange formability, Japanese Unexamined Patent Application Publication No. 11-117039 proposes a high-strength hot-rolled steel sheet having excellent formability, including ductility, shape fixability, and stretch flange formability, with a TS of 540 to 590 MPa. The steel sheet has a composition containing, by mass, 0.010% to 0.10% of C, 0.50% to 1.50% of Si, 0.50% to 2.00% of Mn, 0.01% to 0.15% of F, 0.005% or less of S, 0.001% to 0.005% of N, and at least one of 0.005% to 0.03% of Ti, 0.005% to 0.03% of V, and 0.01% to 0.06% of Nb, the balance being Fe and incidental impurities. The steel sheet ha a microstructure containing 80% to 97% by volume of ferrite phase haying an average grain size of 10 μm or less, the balance being a bainite phase. Japanese Unexamined Patent Application Publication No. 2009-52065 proposes a method of manufacturing a high-strength hot-rolled steel sheet having excellent stretch flange formability after working with a TS of 490 MPa or more. The method uses a steel slab containing, by mass, 0.010% to 0.15% of C, 0.1% to 1.5% of Si, 0.5% to 2.0% of Mn, 0.06% or less of P, 0.005% or less of S, 0.10% or less of Al, and at least one of 0M05% to 0.1% of Ti, 0.005% to 0.1% of Nb, 0.005% to 0.1% of V, and 0.005% to 0.2% of W, the balance being Fe and incidental impurities. The steel slab is heated to 1,150° C. to 1,300° C., then hot-rolled at a finish temperature of 800° C. to 1,000° C., and cooled to a cooling stop temperature of 525° C. to 625° C. at an average cooling rate of 30° Cls or higher. After cooling is stopped (air cooling is allowed) for 3 to 10 seconds, the steel sheet is cooled in a manner that causes nucleate boiling and is coiled at 400° C. to 550° C.

However, the hole expanding ratio, λ, which is a measure of the stretch flange formability of steel sheets, needs to be 125% or more so that they can be formed into various structural components and chassis components of car bodies without problems. With the high-strength hot-rolled steel sheet disclosed in JP '039, it is difficult to achieve a λ of 125% or more. Also, the high-strength hot-rolled steel sheet manufactured by the method disclosed in JP '065 does not necessarily provide a λ of 125% or more,

It could therefore be helpful to provide a high-strength hot-rolled steel sheet having excellent formability that reliably provides a λ of 125% or more and a TS of 490 to less than 590 MPa, and also to provide a method for manufacturing such a high-strength hot-roiled steel sheet.

### SUMMARY

We discovered;
i) A λ of 115% or more and a TS of 490 to less than 590 MPa can be reliably achieved by controlling the composition to term a microstructure in which the area fraction of ferrite phase in the entire structure is 85% or more, the area fraction of bainite phase in the entire structure is 10% or less, the area fraction of phases other than the ferrite and hainite phases in the entire structure is 5% or less, and the area fraction of acicular ferrite phase in the entire ferrite phase is 30% to less than 80%.
ii) Such a microstructure can be fanned primarily by cooling a hot-rolled steel sheet to a cooling stop temperature of 500° C. to 625° C. at an average cooling rate of 50° C./s to 230° C./s, allowing the steel sheet to cool in air, secondarily cooling the steel sheet at an average cooling rate of 100° C./s or higher, and coiling the steel sheet at a coiling temperature of 400° C. to 550° C.

We thus provide a high-strength hot-roiled steel sheet having excellent formability that has a composition containing, by mass, 0.04% to 0.1% of C, 0.3% to 1.3% of Si, 0.8% to 1.8% of Mn, 0.03% or less of P, 0.005% or less of S, 0.005% or less of N, 0.005% to 0.1% of Al, and at least one element selected from 0.002% to less than 0.03% of Ti, 0.002% to less than 0.03% of V, and 0.007% to less than 0.02% of Nb, the balance being Fe and incidental impurities. The steel sheet has a microstructure in which the area fraction of ferrite phase in the entire structure is 85% or more, the area fraction of hainite phase in the entire structure is 10% or less, the area fraction of phases other than the ferrite and bainite phases in the entire structure is 5% or less, and the area fraction of acicular ferrite phase in the entire ferrite phase is 30% to less than 80%.

Preferably, the high-strength hot-rolled steel sheet further contains, by mass, at least one of 0.0005% to 0.005% of Ca and 0.0005% to 0.03% of REM, and 0.0002% to 0.005% of B, separately or simultaneously.

The high-strength hot-rolled steel sheet can be manufactured by a method including hot-rolling a steel slab having the above composition at a finish temperature ranging from an AT₃ transformation point to (Ar₃ transformation point+100)° C., primarily cooling the hot-rolled steel sheet to a cooling stop temperature of 500° C. to 625° C. at an average cooling rate of 50° C./s to 230° C./s, allowing the steel sheet to cool in air for 0.5 second or more, secondarily cooling the steel sheet at an average cooling rate of 100° C./s or higher, and coiling the steel sheet at a coiling temperature of 400° C. to 550° C.

Preferably, the difference between the cooling stop temperature in the primary cooling and the coiling temperature is 100° C. or lower.

We thus provide for the manufacture of a high-strength hot-rolled steel sheet having excellent formability that reliably provides a λ of 125% or more with a TS of 490 to less than 590 MPa. The high-strength hot-rolled steel sheet is suitable for reduced weight of structural components such as members and frames, and chassis components such as suspensions, of car bodies,

### DETAILED DESCRIPTION

Our steel sheets and methods will now be specifically described, where the “%” sign concerning composition refers to “% by mass” unless otherwise indicated.

### 1) Composition

C: 0.04% to 0.1%

C is an element effective in ensuring the necessary strength. A C content of 0.04% or more is needed to provide a TS of 490 MPa or more, A C content above 0.1%, however, decreases the total elongation, El, and λ. Thus, the C content is 0.04% to 0.1%, more preferably 0.05% to 0.09%.
Si: 0.3% to 1.3%

Si is an element necessary to increase the strength by solid-solution strengthening. A Si content below 0.3% requires a larger amount of expensive alloying clement to be added to provide a TS of 490 MPa or more, A Si content above 1.3%, on the other hand, significantly degrades the surface quality. Thus, the Si content is 0.3% to 1.3%, more preferably 0.4% to 1.0%.
Mn: 0.8% to 1.8%

Mn is an element effective for solid-solution strengthening and formation of bainite phase. A Mn content of 0.8% or more is needed to provide a TS of 490 MPa or more. A Mn content above 1.8%, however, decreases the weldability. Thus, the Mn content is 0.8% to 1.8%, more preferably 0.8% to 1.3%.
P: 0.03% or less

A P content above 0.03% results in decreased El and λ due to segregation. Thus, the P content is 0.03% or less.
S: 0.005% or less

S forms sulfides of Mn and Ti to decrease El and λ and also to decrease the contents of Mn and Ti, which are effective elements for strengthening, although a S content of up to 0.005% is acceptable. Thus, the S content is 0.005% or less, more preferably 0.003% or less.
N: 0.005% or less

A high N content above 0.005% is detrimental because a large amount of nitride forms duritig the manufacturing process and decreases the-hot ductility. Thus, the N content is 0.005% or less.
Al: 0.005% to 0.1%

Al is an element important as a deoxidizer for the steel and, to this end, an Al content of 0.005% or More is needed. An Al content above 0.1%, however, makes it difficult to cast the steel and leaves a large amount of inclusions in the steel, thus degrading the material and surface qualities. Thus, the Al content is 0.005% to 0.1%.
At Least One Element Selected from 0.002% to Less Than 0.03% of Ti, 0.002% to Less Than 0.03% of V, and 0.002% to Less Than 0.02% of Nb

Ti, V, and Nb are elements that contribute to strengthening by combining in part with C and N to form fine carbides and nitrides. To produce this effect, at least one clement selected from Ti, V, and Nb needs to be contained, and the content of the element needs to be 0.002% or more, A Ti or V content of 0.03% or more or a Nb content of 0.02% or more, however, considerably decreases El and while increasing the strength, which does not result in a desired balance between strength and formability. Thus, the Ti content is 0.002% to less than 0.03%, the V content is 0.002% to less than 0.03%, and the Nb content is 0.002% to less than 0.02%. More preferably, the Ti and V contents are 0.029% or less, and the Nb content is 0.019% or less.

The balance is Fe and incidental impurities, although at least one of 0.0005% to 0.005% of Ca and 0.0005% to 0.01% of REM and 0.0002% to 0.005% of B are preferably contained separately or simultaneously for the following reasons.
Ca: 0.0005% to 0.005%, REM: 0.0005% to 0.03%

Ca and REM are elements effective for morphology control of inclusions and contribute to increased El and λ. To produce this effect, a Ca or REM content of 0.0005% or more is preferred. A Ca content above 0.005% or a REM content above 0.03%, however, increases the amount of inclusions in the steel and therefore degrades the material quality thereof Thus, the Ca content is preferably 0.0005% to 0.005%, and the REM content is preferably 0.0005% to 0.03%.
B: 0.0002% to 0.005%

B is an element advantageous to form acicular ferrite and, to this end, 0.0002% or more of B needs to be added. A B content above 0.005%, however, produces no greater effect, and the effect is not commensurate with cost. Thus, the B content is 0.0002% to 0.005%.

### 2) Microstructure

The high-strength hot-rolled steel sheet contains a ferrite phase composed of polygonal ferrite phase and acicular ferrite phase and having a bainite phase dispersed therein and has a microstructure in which the area fraction of the ferrite phase in the entire structure is 85% or more, the area fraction of the bainite phase in the entire structure is 10% or less, the area fraction of phases other than the ferrite and bainite phases in the entire structure is 5% or less, and the area fraction of the acicular ferrite phase in the entire ferrite phase is 30% to less than 80%. Controlling the area fractions of the bainite and ferrite phases in this manner provides high El while ensuring a TS of 490 to less than 590 MPa. In addition, controlling, the area fraction of the acicular ferrite phase in this manner reduces the difference in hardness between the ferrite phase and the hainite phase, thereby providing a λ of 125% or more. Preferably, the area traction of the acicular ferrite phase is 30% to 79%.

The presence of phases other than the ferrite and bainite phases such as pearlite phase, retained austenite phase, and martensite phase, does not impair our advantages as long as the area fraction thereof in the entire structure is 5% or less. Thus, the area fraction of phases other than the ferrite and bainite phases (the sum of the area fractions of other phases) is 5% or less.

The area fractions of the ferrite phase, the hainite phase, and the other phases are determined by removing a test specimen for scanning electron microscopy (SEM), polishing and then corroding with nital a eross-section cut across the thickness and parallel to the rolling direction, capturing 10 SEM images with different fields of view in the center of the thickness at 1,000× and 3,000× magnifications, extracting the ferrite phase, the bainite phase, and the other phases by image processing, measuring the areas of the ferrite phase, the bainite phase, the other phases, and the examination field of view by image analysis processing, and aculating the respective area fractions by (area of phase)/(area of examination field of view)×100(%). The area fraction of the acicular ferrite phase in the entire ferrite phase is determined by measuring the area of the acicular ferrite phase in the same manner and calculating the area fraction thereof by (area of acicular ferrite phase)/(area of examination field of view−area of bainite phase−area of other phases)×100 (%).

The ferrite phase is a portion that appears gray in a 1,000× SEM image, and the second phases are portions, excluding grain boundaries, that appear white. Of the second phases, grains having an internal structure in which carbides, for example, are observed in a 3,000× SEM image are defined as the bainite phase. It should be noted, however, that a portion having a lamellar structure with a pitch of 0.05 μm or more in the internal structure is defined, as pearlite and excluded from the bainite phase. Unlike the polygonal ferrite phase, which is equiaxial, the acicular ferrite phase is observed as a phase composed of elongated ferrite grains, and a phase composed of ferrite grains satisfying major axis/minor axis≧1.5 is defined as the acicular ferrite phase, where the major axis is the longest diameter of each ferrite grain, and the minor axis is the shortest diameter of each ferrite grain in a direction perpendicular thereto.

Whereas the area fraction of the acicular ferrite phase may be directly determined, as described above, it can also be determined by subtracting the area fraction of the polygonal ferrite phase from the area fraction of the ferrite phase. In this case, the polygonal ferrite phase is defined as a phase composed of ferrite grains satisfying major axis/minor axis<1.5.

### 3) Manufacturing Conditions

Finish Temperature in Hot Rolling: Ar₃ Transformation Point to (Ar₃ Transformation Point+100)° C.

A finish temperature below the Ar₃ transformation point results in formation of coarse grains and mixed grains in the surface layer of the steel sheet, thus decreasing, El and λ. A finish temperature above (Ar₃ transformation point+100)° C. coarsens crystal grains, thus providing no desired properties. Thus, the finish temperature is the Ar transformation point to (Ar₃ transformation point+100)° C. or higher.

The Ar₃ transformation point is the transformation temperature determined from a point of change in a thermal expansion curve obtained by a working Formaster test carried out at a cooling rate of 10° C./s.

Primary Cooling Conditions after flat Rolling: Average Cooling Rate of 50° C./s to 230° C./s, Cooling Stop Temperature of 500° C. to 625° C.

An average cooling rate below 50° C./s during primary cooling after hot rolling does not allow the desired amount of acicular ferrite phase to be funned because ferrite transformation starts in a high-temperature range. Again, an average cooling rate above 230°C./s during primary cooling does not allow the desired amount of acicular ferrite phase to be formed. Thus, the average cooling rate during primary cooling is 50° C./s to 230° C./s, preferably 70° C./s or higher, more preferably 100° C./s or higher. Primary cooling can be performed in any manner such as using a known water cooling system based on laminar cooling.

Primary cooling needs to be stopped at a cooling stop temperature of 500° C. to 625° C. because a cooling stop temperature below 500° C. results in formation of an excessive amount of bainite phase, and a cooling stop temperature above 625° C. does not allow the desired amount of acicular ferrite phase to be formed.

More preferably, the cooling stop temperature is 500° C. to 550° C. A cooling stop temperature above 550° C. tends to coarsen the acicular ferrite phase and therefore the desired λ might not be obtained.

### Air Cooling Time After Primary Cooling: 0.5 Second or More

The air cooling time after primary cooling is crucial in forming the desired microstructure. In particular, after primary cooling, cooling is stopped and air cooling is allowed to form the proper amount of bainite phase. An air cooling time below 0.5 second does not allow the desired amount of bainite phase to be formed because an insufficient amount of carbon concentrates in austenite phase. Thus. the air cooling time after primary cooling is 0.5 second or more. Preferably, the air cooling time is 5 seconds or less.

Secondary Cooling Conditions after Air Cooling: Average Cooling, Rate of 100° C./s or Higher

After air cooling, secondary cooling needs to be performed to the coiling temperature at an average cooling rate of 100° C./s or higher so that the amount of ferrite phase formed, which has been adjusted during air cooling, does not vary. Secondary cooling can be performed in any manner such as using a known water cooling system based on laminar cooling.

### Coiling Temperature: 400° C. to 550° C.

Coiling, needs to be performed at a coiling temperature of 400° C. to 550° C. to transform the austenite phase maintained after secondary cooling into bainite phase. A coiling temperature below 400° C. results in formation of a martensite phase, which is harder than the bainite phase, whereas a coiling temperature above 550° C. results in formation of a pearlite phase, which decreases El and λ.

For higher stretch flange formability, the difference between the cooling stop temperature in primary cooling, and the coiling temperature is preferably 100° C. or lower. This reduces the difference in hardness between the main phase, i.e., the ferrite phase, and the second phases such as the bainite phase, which are harder, thus improving λ.

The remaining manufacturing conditions may be as usual. For example, a steel having the desired composition is produced by melting, in a converter or electric furnace and then secondary refining in a vacuum degassing furnace. The subsequent casting step is preferably performed by continuous casting for high productivity and quality. The slabs formed by casting may be normal slabs having a thickness of about 200 to 300 mm or thin slabs having a thickness of about 30 mm. Thin slabs do not require rough rolling. After casting, the slabs as cast may be subjected to hot direct rolling Or to hot rolling after reheating in a heating furnace.

The high-strength hot-rolled steel sheet can become a plated steel sheet such as an electrogalvanized steel sheet, a hot-dip galvanized steel sheet, or a galvannealed steel sheet.

### EXAMPLES

Steel Slabs Nos, A to I, which had the compositions and Ar₃ transformation points shown in Table 1, were heated to 1,250° C. and were hot-rolled to a thickness of 3 mm under the conditions shown in Table 2 to produce Hot-Rolled Steel Sheets Nos. 1 to 13. The Ar, transformation points in Table 1 were determined in the manner described above.

The area fractions of the ferrite and bainite phases in the entire structure and the area fraction of the acicular ferrite phase in the entire ferrite phase were determined in the manner described above, in addition, ES No. 5 tensile test specimens (perpendicular to the rolling direction) and hole expanding test specimens (130 mm square) were removed and used to determine TS, El, and λ in the following manner.
TS, El: The IS and El of three tensile test specimens were measured by a tensile test at a strain rate of 10 mm/min in accordance with JIS Z 2241 and were averaged.
λ: A hole expanding test was performed on three test specimens by forming a hole with a diameter of 10 mm in the center of the test specimens and forcing a 60° conical punch up into the hole at the opposite side from the burr in accordance with the Japan Iron and Steel Federation Standard HST 1001 to measure the hole diameter, d mm, when a crack penetrated the test specimens across the thickness thereof. The values of λ of the three test specimens were calculated by the following equation and were averaged to evaluate a λ:

(%)=[(d−10)/10]×100,

The results are shown in Table 3, The results demonstrate that the Invention Examples had a TS of 490 to less than 590 MPa and also had excellent formability with an El of 29% or more and a λ of 125% or more.

TABLE 1
% by mass

| Steel | | | | | | | | | | | | Ar₃ trans- | |
|---|---|---|---|---|---|---|---|---|---|---|---|---|---|
| slab | | | | | | | | | | | | formation | |
| No. | C | Si | Mn | P | S | N | Al | Ti | Nb | V | Others | point (° C.) | Remarks |
| A | 0.050 | 0.39 | 1.36 | 0.007 | 0.0031 | 0.0041 | 0.051 | — | 0.002 | 0.019 | Ca: 0.0033 | 851 | Within scope of |
| | | | | | | | | | | | | | invention |
| B | 0.072 | 0.66 | 1.16 | 0.010 | 0.0005 | 0.0019 | 0.019 | 0.016 | — | — | — | 843 | Within scope of |
| | | | | | | | | | | | | | invention |
| C | 0.090 | 0.81 | 1.22 | 0.021 | 0.0011 | 0.0038 | 0.044 | — | 0.007 | — | — | 836 | Within scope of |
| | | | | | | | | | | | | | invention |
| D | 0.077 | 0.69 | 1.15 | 0.014 | 0.0009 | 0.0022 | 0.032 | 0.029 | 0.002 | 0.002 | — | 844 | Within scope of |
| | | | | | | | | | | | | | invention |
| E | 0.041 | 0.42 | 0.92 | 0.028 | 0.0010 | 0.0047 | 0.063 | 0.003 | — | 0.029 | B: 0.0011 | 849 | Within scope of |
| | | | | | | | | | | | | | invention |
| F | 0.055 | 0.52 | 0.83 | 0.018 | 0.0016 | 0.0015 | 0.021 | 0.004 | 0.019 | — | REM: 0.0018 | 866 | Within scope of |
| | | | | | | | | | | | | | invention |
| G | 0.095 | 0.56 | 1.21 | 0.014 | 0.0018 | 0.0033 | 0.037 | 0.045 | — | 0.025 | — | 841 | Beyond scope |
| | | | | | | | | | | | | | of invention |
| H | 0.061 | 0.41 | 1.75 | 0.022 | 0.0011 | 0.0052 | 0.055 | 0.011 | 0.018 | — | — | 831 | Beyond scope |
| | | | | | | | | | | | | | of invention |
| I | 0.088 | 0.92 | 1.36 | 0.017 | 0.0014 | 0.0047 | 0.062 | — | 0.039 | — | — | 850 | Beyond scope |
| | | | | | | | | | | | | | of invention |

TABLE 2

| | | | | | | Secondary | | | |
|---|---|---|---|---|---|---|---|---|---|
| | | | Primary cooling | | | cooling | | | |
| | | | conditions | | Air | conditions | Coiling | | |
| Hot-rolled | Steel | Finish | Average | Cooling stop | cooling | Average | temperature | | |
| steel sheet | slab | temperature | cooling rate | temperature | time | cooling rate | Tc | (Ts − Tc) | |
| No. | No. | (° C.) | (° C./s) | Ts (° C.) | (s) | (° C./s) | (° C.) | (° C.) | Remarks |
| 1 | A | 865 | 60 | 615 | 2.2 | 125 | 505 | 110 | Invention example |
| 2 | B | 935 | 125 | 620 | 2.4 | 115 | 515 | 105 | Invention example |
| 3 | B | 885 | 110 | 500 | 4.4 | 185 | 450 | 50 | Invention example |
| 4 | C | 890 | 235 | 530 | 0.2 | 155 | 430 | 100 | Comparative example |
| 5 | C | 895 | 155 | 565 | 2.7 | 140 | 495 | 70 | Invention example |
| 6 | C | 925 | 145 | 610 | 5.9 | 205 | 425 | 185 | Invention example |
| 7 | D | 890 | 315 | 505 | 3.9 | 155 | 410 | 95 | Comparative example |
| 8 | E | 880 | 115 | 650 | 4.5 | 160 | 540 | 110 | Comparative example |
| 9 | F | 920 | 175 | 545 | 2.7 | 115 | 385 | 160 | Comparative example |
| 10 | G | 860 | 190 | 495 | 3.3 | 185 | 415 | 80 | Comparative example |
| 11 | H | 845 | 95 | 550 | 0.4 | 105 | 395 | 155 | Comparative example |
| 12 | I | 840 | 140 | 585 | 1.9 | 135 | 475 | 110 | Comparative example |
| 13 | B | 895 | 205 | 545 | 0.9 | 105 | 435 | 110 | Invention example |

TABLE 3

| | Area fraction | Area fraction | Area fraction | Area fraction of | | | | |
|---|---|---|---|---|---|---|---|---|
| Hot-rolled | of ferrite | of bainite | of other | acicular ferrite phase | | | | |
| steel | phase | phase | phases | in ferrite phase | TS | EI | λ | |
| sheet No. | (%) | (%) | (%) | (%) | (MPa) | (%) | (%) | Remarks |
| 1 | 94 | 2 | 4 | 65 | 529 | 37.5 | 175 | Invention example |
| 2 | 91 | 8 | 1 | 52 | 505 | 39.5 | 195 | Invention example |
| 3 | 90 | 9 | 1 | 79 | 568 | 36.5 | 185 | Invention example |
| 4 | 96 | 3 | 1 | 92 | 630 | 28.0 | 130 | Comparative example |
| 5 | 93 | 7 | 0 | 77 | 550 | 38.5 | 185 | Invention example |
| 6 | 93 | 3 | 4 | 61 | 575 | 35.0 | 145 | Invention example |
| 7 | 92 | 3 | 5 | 99 | 651 | 26.0 | 105 | Comparative example |
| 8 | 90 | 9 | 1 | 28 | 498 | 29.0 | 120 | Comparative example |
| 9 | 88 | 3 | 9 | 55 | 645 | 27.5 | 100 | Comparative example |
| 10 | 97 | 2 | 1 | 96 | 660 | 24.0 | 105 | Comparative example |
| 11 | 24 | 71 | 5 | 97 | 685 | 23.5 | 90 | Comparative example |
| 12 | 97 | 1 | 2 | 98 | 635 | 23.0 | 125 | Comparative example |
| 13 | 96 | 3 | 1 | 76 | 544 | 37.5 | 185 | Invention example |

1. A high-strength hot-rolled steel sheet having excellent formability, comprising a composition containing, by mass, 0.04% to 0.1% of C, 0.3% to 1.3% of Si, 0.8% to 1.8% of Mn, 0.03% or less of P, 0.005% or less of S, 0.005% or less of N, 0.005% to 0.1% of Al, and at least one element selected from 0.002% to less than 0.03% of Ti, 0.002% to less than 0.03% of V, and 0.002% to less than 0.02% of Nb, the balance being Fe and incidental impurities, the steel sheet having a microstructure in which an area fraction of a ferrite phase in the structure is 85% or more, an area fraction of a bainite phase in the structure is 10% or less, an area fraction of phases other than the ferrite and bainite phases in the structure is 5% or less, and an area fraction of an acicular ferrite phase in the ferrite phase is 30% to less than 80%.

2. The steel sheet according to claim 1, further comprising, by mass, at least one of 0.0005% to 0.005% of Ca and 0.0005% to 0.03% of REM.

3. The steel sheet according to claim 1, further comprising, by mass, 0.0002% to 0.005% of B.

4. A method of manufacturing a high-strength hot-rolled steel sheet having excellent formability, comprising:
hot-rolling a steel slab having the composition according to claim 1 at a finish temperature of an Ar₃ transformation point to (Ar₃ transformation point+100)° C.,
primarily cooling the hot-rolled steel sheet to a cooling stop temperature of 500° C. to 625° C. at an average cooling rate of 50° C./s to 230° C./s,
allowing the steel sheet to cool in air for 0.5 second or more,
secondarily cooling the steel sheet at an average cooling rate of 100° C./s or higher, and
coiling the steel sheet at a coiling temperature of 400° C. to 550° C.

5. The method according to claim 4, wherein a difference between the cooling stop temperature in the primary cooling and the coiling temperature is 100° C. or lower.

6. The steel sheet according to claim 2, further comprising, by mass, 0.0002% to 0.005% of B.

7. A method of manufacturing a high-strength hot-rolled steel sheet having excellent formability, comprising:
hot-rolling a steel slab having the composition according to claim 2 at a finish temperature of an Ar3 transformation point to (Ar3 transformation point+100)° C.,
primarily cooling the hot-rolled steel sheet to a cooling stop temperature of 500° C. to 625° C. at an average cooling rate of 50° C./s to 230° C./s,
allowing the steel sheet to cool in air for 0.5 second or more,
secondarily cooling the steel sheet at an average cooling rate of 100° C./s or higher, and
coiling the steel sheet at a coiling temperature of 400° C. to 550° C.

8. A method of manufacturing a high-strength hot-rolled steel sheet having excellent formability, comprising:
hot-rolling a steel slab having the composition according to claim 3 at a finish temperature of an Ar3 transformation point to (Ar3 transformation point+100)° C.,
primarily cooling the hot-rolled steel sheet to a cooling stop temperature of 500° C. to 625° C. at an average cooling rate of 50° C./s to 230° C./s,
allowing the steel sheet to cool in air for 0.5 second or more,
secondarily cooling the steel sheet at an average cooling rate of 100° C./s or higher, and
coiling the steel sheet at a coiling temperature of 400° C. to 550° C.

9. A method of manufacturing a high-strength hot-rolled steel sheet having excellent formability, comprising:
hot-rolling a steel slab having the composition according to claim 6 at a finish temperature of an Ar3 transformation point to (Ar3 transformation point+100)° C.,
primarily cooling the hot-rolled steel sheet to a cooling stop temperature of 500° C. to 625° C. at an average cooling rate of 50° C./s to 230° C./s,
allowing the steel sheet to cool in air for 0.5 second or more,
secondarily cooling the steel sheet at an average cooling rate of 100° C./s or higher, and
coiling the steel sheet at a coiling temperature of 400° C. to 550° C.
